(19) United States
(12) Patent Application Publication
(10) Pub. No.: US 2018/0357678 A1
(43) Pub. Date: Dec. 13, 2018

(54) OFFLINE CONVERSION TRACKING

(71) Applicant: Google Inc., Mountain View, CA (US)

(72) Inventors: Jonathan R. Diorio, Mountain View, CA (US); Monica D. Chawathe, Los Altos, CA (US); Ajit Apte, Mountain View, CA (US)

(21) Appl. No.: 13/943,001

(22) Filed: Jul. 16, 2013

(51) Int. Cl. G06Q 30/02

(52) U.S. Cl. CPC G06Q 30/0275

(57) ABSTRACT

Methods, systems, and apparatus, including computer programs encoded on a computer storage medium, for tracking and utilizing offline conversion data are disclosed. In one aspect, a method includes receiving, from a user device, interaction data specifying the occurrence of a particular user interaction with the content item. An updated path for a landing page of the content item is provided to the user device. The updated path includes an interaction identifier that represents the particular user interaction. Offline conversion data are received from a content sponsor associated with the content item. The offline conversion is attributed to the particular user interaction based on the interaction identifier being included in the offline conversion data. An adjusted bid is determined based on the offline conversion data and a bid associated with the content item. The adjusted bid is submitted to a content item selection process.

### BACKGROUND

This specification relates to data processing.

The Internet facilitates the exchange of information and transactions between users across the globe. This exchange of information enables content item providers to provide sponsored content to a variety of users. A content item provider can control the distribution of their content items (e.g., promotions, advertisements, audio files, video files, or other content items) based on a set of parameters that specify under what conditions a content item is eligible to be distributed. When a presentation opportunity meeting the conditions is available, the content item is deemed eligible to be provided for presentation.

### SUMMARY

In general, one innovative aspect of the subject matter described in this specification can be embodied in methods that include the actions of receiving, from a user device, interaction data specifying the occurrence of a particular user interaction with a content item; providing, to the user device, an updated path for a landing page of the content item, the updated path including an interaction identifier that represents the particular user interaction; receiving, from a content sponsor associated with the content item, offline conversion data that specifies information corresponding to an offline conversion and that includes the interaction identifier; attributing the offline conversion to the particular user interaction based on the interaction identifier being included in the offline conversion data; determining an adjusted bid based at least in part on the offline conversion data and a bid associated with the content item; and submitting the adjusted bid to a content item selection process. Other embodiments of this aspect include corresponding systems, apparatus, and computer programs, configured to perform the actions of the methods, encoded on computer storage devices.

These and other embodiments can each optionally include one or more of the following features. Providing an updated path can include receiving, from the user device, data identifying a landing page being requested in response to user interaction with the content item; appending the interaction identifier to the data identifying the landing page; and providing, to the user device, an updated path for requesting the landing page, the updated path including the interaction identifier.

Methods can include the actions of storing, in a data store, the interaction identifier in association with contextual data corresponding to the user interaction; and updating stored conversion data for the content item. The updating can include identifying the stored interaction identifier in response to receiving the offline conversion data; and storing at least a portion of the offline conversion data in association with the stored interaction identifier.

Determining an adjusted bid can include generating a bid adjustment factor based at least in part on a conversion specified by the offline conversion data; and generating the adjusted bid based on the bid adjustment factor and the bid associated with the content item.

Generating a bid adjustment factor can include generating a different adjustment factor for each of at least two different sets of contextual data associated with the updated stored conversion data, a difference between the different adjustment factors being based, at least in part, on a difference between different conversion values associated with the at least two different sets of contextual data.

Methods can include the actions of receiving a content item request specifying one or more contextual parameters corresponding to the content item request; identifying a set of contextual data that is matched by the one or more contextual parameters; and generating an adjusted bid based on the adjustment factor for the matched set of contextual data.

Generating a bid adjustment factor can include identifying first contextual data corresponding to the particular user interaction; identifying offline conversion data for other conversions having contextual data that match the first contextual data; and generating a bid adjustment value based on a value of the offline conversion corresponding to the interaction identifier, conversion values associated with the other conversions, and a difference between an estimated value of a current impression corresponding to the content item request and a baseline value representing a value of multiple previous impressions.

Particular embodiments of the subject matter described in this specification can be implemented so as to realize none, one or more of the following advantages. Merchants are provided with the ability to evaluate how their online activities result in offline conversions. Offline conversions can be attributed to a particular user interaction (e.g., click), thereby enabling the merchant to identify the specific online activity to which the offline conversion relates. The offline conversion attribution information enables merchants that receive offline conversions to utilize campaign adjustment features that utilize conversion information to adjust, for example, advertisement bids for online advertising.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which offline conversion tracking can be performed.

FIG. 2 is a block diagram of an example data flow for tracking offline conversions.

FIG. 3 is a flow chart of an example process for tracking offline conversions.

FIG. 4 is a block diagram of an example computer system.

Like reference numbers and designations in the various drawings indicate like elements.

### DETAILED DESCRIPTION

Content sponsors that distribute content items (e.g., advertisements) in an online environment may enter into transactions in an offline environment (e.g., through in-person negotiations and/or contract execution). Content sponsors can make use of various technologies, such as automated bid adjustment technologies, to adjust serving parameters associated with their sponsored content. Content sponsors can use their offline conversion data and data corresponding to the online content items that led to the offline transaction. For example, as described in more detail below, when a user interacts with an online content item, the user device at which the interaction occurred is directed to an apparatus that generates an interaction identifier that uniquely identifies the user interaction with the content item.

The interaction identifier can be stored in a data store along with contextual data corresponding to the interaction. The interaction identifier can also be provided to the user device, which can then be redirected to a landing page for the content item. For example, the interaction identifier can be appended to a Uniform Resource Locator (“URL”) for the landing page, resulting in an updated path for the landing page that is used by the user device to request the landing page. When data, such as information related to a sales lead, is submitted at the landing page (or another page associated with the content sponsor), the interaction identifier can be obtained from the updated path, and included in the submitted information.

When the content sponsor and an entity associated with the submitted information enter into a transaction that constitutes an event (e.g., a conversion such as a sales transaction), the content sponsor can update information associated with the interaction identifier to include data, such as a transaction value, and then submit the data, including the interaction identifier, to the offline conversion apparatus. Using the interaction identifier, an apparatus can identify a matching interaction identifier in the stored data, and update the stored data to include the data submitted by the content sponsor, for example, by attributing the offline conversion to the particular user interaction for which the interaction identifier was created. This offline conversion data can then be used, for example, to vary bids for content items that are distributed for the content sponsor, based on an estimated value of an impression and/or a probability that a conversion will occur (e.g., based on historical conversion data provided by the content sponsor).

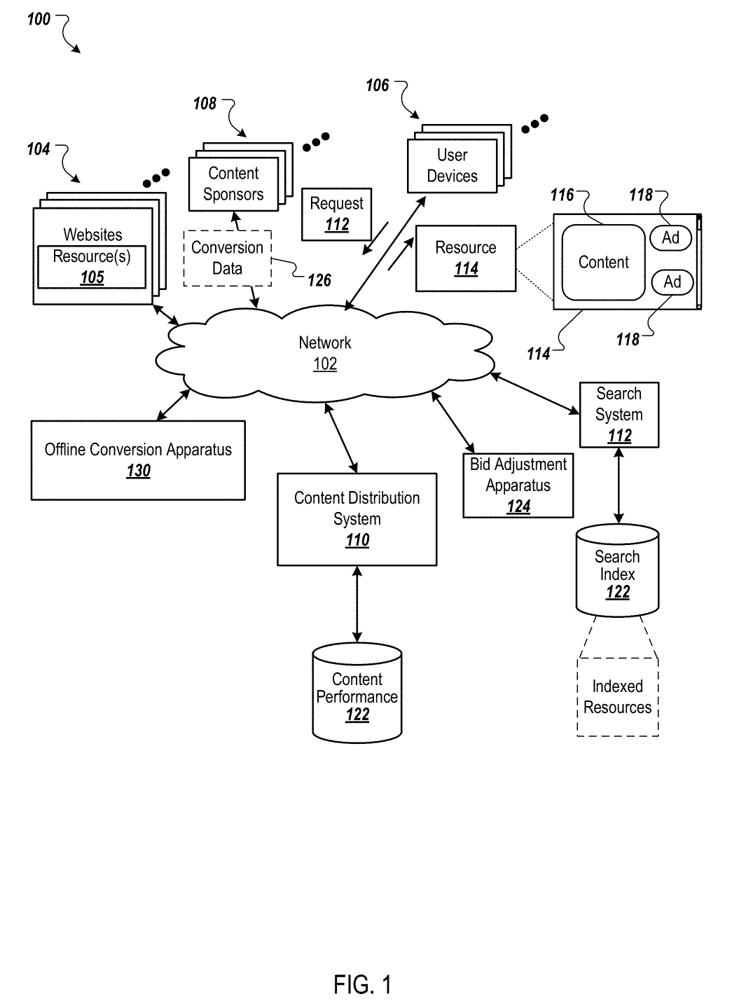

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, content sponsors 108, and a content distribution system 110. The example environment 100 may include many different websites 104, user devices 106, and content sponsors 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Websites 104 can be maintained by a publisher, which can be an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items, and an individual content item can be stored in a single file or set of files independent of the resource.

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104, web page from a social network, or another resource 105. The data representing the requested resource 114 can include data that cause presentation of resource content 116 at the user device 106. The data representing the requested resource 114 can also include data specifying content item slots 118. A content item slot is a portion of the resource (e.g., a portion of a web page) or a portion of a user display (e.g., a presentation location of another window or in a slot of a web page) in which content items, such as advertisements, can be presented. Content items slots 118 can also be referred to as advertisement slots, but any type of content (e.g., content items other than advertisements) can be presented in these content item slots 118.

To facilitate searching of these resources, the environment 100 can include a search system 112 that identifies the resources by crawling and indexing the resources provided by the publishers on the websites 104. Data about the resources can be indexed based on the resource with which the data are associated. The indexed and, optionally, cached copies of the resources are stored in a search index 122. Data that are associated with a resource is data that represents content included in the resource and/or metadata for the resource.

User devices 106 can submit search queries to the search system 112 over the network 102. In response, the search system 112 accesses the search index 122 to identify resources that are relevant to the search query. The search system 112 identifies the resources in the form of search results and returns the search results to the user device in search results page. A search result is data generated by the search system 112 that identifies a resource that is responsive to a particular search query, and includes a link to the resource. An example search result can include a web page title, a snippet of text or a portion of an image extracted from the web page, and the URL of the web page. Like other resources, search results pages can include one or more content item slots in which content items, such as advertisements, can be presented.

When a resource 105 is requested by a user device 106, execution of code associated with a slot in the resource initiates a request for a content item to populate the slot. When a resource 105 requests a content item, the presentation of the content item is referred to as an impression.

In some implementations, impressions are allocated by a content distribution system 110. For example, some publishers enter into an agreement to have slots on their resources 105 populated by third party content items selected by the content distribution system 110. In some implementations, the publisher can include, in their resource 105, code that when executed by the user device 106, submits a request (i.e., a content item request) to the content distribution system 110.

The request can include characteristics of the slots that are defined for the requested resource 114. For example, a reference (e.g., URL) to the requested resource 114 for which the slot is defined, a size of the slot, and/or media types that are eligible for presentation in the slot can be provided to the content distribution system 110. Similarly, keywords associated with a requested resource (“resource keywords”) or entities that are referenced by the resource can also be provided to the content distribution system 110 to facilitate identification of content items that are relevant to the requested resource 114. The requests can also include other information, such as information that the user has provided, geographic information indicating a state or region from which the request was submitted, or other information that provides context for the environment in which the content item will be displayed (e.g., a type of device on which the content item will be displayed, such as a mobile device or tablet device).

The content items that are provided in response to a request (or another content item request) are selected based at least in part on distribution parameters associated with the content items. Distribution parameters are a set of criteria upon which distribution of content items are conditioned. In some implementations, the distribution criteria for a particular content item can include distribution keywords that must be matched (e.g., by resource keywords or search queries) in order for the content item to be eligible for presentation. The distribution criteria can also specify a bid and/or budget for distributing the particular content item. In some implementations, bids can be used in an auction to select which content item(s) will be presented and/or in which slot the content item(s) will be presented. A content item provider can specify a budget, which will limit the maximum amount that the content item provider will spend over a specified period.

Some content item providers specify different bids for different sets of distribution parameters. For example, assume that a content item provider that distributes a content item related to a college basketball team from Michigan specifies a first set of distribution parameters that includes the distribution keyword “basketball.” Content items distributed based on this first set of distribution parameters will be eligible for presentation when the keyword “basketball” is matched by data included in a content item request, and the content item provider may be willing to pay a specified price for distribution of content items based on the first set of distribution parameters.

Continuing with this example, the content item provider may also specify a second set of distribution parameters that includes the distribution keyword “basketball” and also includes an additional distribution parameter, such as a geographic distribution parameter (e.g., Michigan). The geographic distribution parameter can require, for example, a content item request to include data referencing a particular geographic location, or one of multiple specified geographic locations, in order for a content item to be marked as eligible to be provided in response to the request. To illustrate, the content item provider in the example above may only want a particular set of content items distributed in response to content item requests that reference Michigan, since the college basketball team is located in Michigan. The content item provider may include the additional distribution parameter “Michigan” in the second set of distribution parameters. Because the second set of distribution parameters is more restrictive than the first set of distribution parameters, e.g., requiring the content item request to include data matching the keyword “basketball” and include a reference to Michigan, the content item provider may associate a higher bid with the second set of distribution parameters.

The content distribution system 110 uses the specified distribution parameters to distribute content items for the content sponsors 108. The content distribution system 110 also stores interaction data specifying, for example and for each impression, whether a user interacted with (e.g., clicked) the content item. For example, when a user clicks on a content item, code included in the content item can initiate a request for a landing page referenced by the content item. Code included in the content item can also cause data representing the interaction to be transmitted to the content distribution system.

In some implementations, prior to requesting the landing page, location information can be retrieved. For example, the code can cause the user device to submit a request for a network location associated with the content distribution system 110 (or an analytics apparatus). The request can include interaction data specifying the content item that the user interacted with and contextual data specifying the environment in which the interaction occurred. The data included in the request can be appended, for example, to the network location that is requested. For example, the request can take the form of http://www.example.com/?click=click_data&dest=landingpage, where “example.com” is the network location of the content distribution system, “?click” specifies that the data appended to the network location relates to a click of a content item, the data following “=” is the data specifying the content item that was interacted with (e.g., clicked) and the contextual data, and the data following “&dest=” is the network address of the landing page for the content item.

When the content distribution system 110 receives the request, the content distribution system 110 stores the interaction data included in the request, for example, in a content performance data store 122. The content distribution system 110 also redirects the user device to the landing page for the content item.

Some content sponsors 108 track conversions that occur at their websites 104, which is referred to as online conversion tracking. In some implementations, the online conversion tracking is facilitated by conversion tracking code that the content sponsor includes on one or more pages of their website. For example, a content sponsor can include, on a “thank you” page that is presented following a user purchase, a portion of code that causes conversion data to be transmitted to the content distribution system 110. The conversion data can include, for example, details about the conversion that the user performed (e.g., a value of a sale and which content item the user last interacted with prior to the conversion). The conversion data can be stored, for example, in the content performance data store 122.

In some implementations, the content distribution system 110 uses the interaction data and/or conversion data to adjust bids for a content sponsor 108. For example, the content distribution system 110 can provide the interaction data and/or conversion data to a bid adjustment apparatus 124 that determines, based on the interaction data and/or conversion data, types of impressions having a higher conversion likelihood than other types of impressions. Using the conversion likelihood data, the bid adjustment apparatus 124 can specify different bids for different impression types, thereby facilitating per-impression bid adjustment. For example, for each different impression type, the bid adjustment apparatus 124 can determine a likelihood that the impression will lead to a conversion, and assign a bid adjustment factor to that impression type.

The bid adjustment factor can be, for example, a value between 0.0 and 1.0 (or another value) that is multiplied with (or otherwise applied to) the maximum bid that is specified by the content sponsor when a content item request is requesting a content item for an impression corresponding to that particular impression type. For example, for impression types (e.g., content item requests associated with a particular geographic location) that very rarely lead to a conversion, or only lead to low value conversions, the bid adjustment factor can be closer to 0.0. than 1.0, whereas the bid adjustment factor for impression types that have higher conversion rate can be closer to 1.0.

When the content distribution system 110 receives a content item request, the content distribution system 110 can identify an impression type associated with the content item request, and select the bid adjustment factor to be applied to the content sponsor's bid to obtain an adjusted bid. In turn, the adjusted bid can be submitted to an auction that is used to select one or more content items to be provided in response to the content item request.

The online conversion tracking and bid adjustment techniques described above generally require that the conversion take place through an online resource, and that the content sponsor include a specific portion of code in at least one of their resources. Thus, content sponsors that generally realize conversions in an offline environment (e.g., by entering into a purchase agreement outside of the online environment 100) or that are unable to include conversion tracking code in one of their online resources may not be able to accurately track conversions and/or utilize the bid adjustment features that are available to those content sponsors that are able to utilize the online conversion tracking.

The environment 100 includes an offline conversion apparatus 130 that facilitates offline conversion tracking and attribution of offline conversions to particular online user interactions. The offline conversion apparatus 130 can include multiple different devices that are in communication with each other or that are utilizes by a common entity. For example, the offline conversion apparatus 130 can include, or be in communication with one or more different data stores that may also be used by other data processing apparatus. Thus, the data stores can store data for multiple different data processing apparatus. The offline conversion apparatus can also include, be in association with, or access data stored by an interaction apparatus (e.g., click server).

In some implementations, the offline conversion tracking apparatus 130 appends an interaction identifier to the request for a landing page that is generated through user interaction with a content item, and a different identifier can be appended to each different request. As described in detail below, the content sponsor 108 can associate this interaction identifier with an offline conversion that subsequently occurs, and then provide this interaction identifier to the offline conversion apparatus with offline conversion data 126. The offline conversion data 126 include information about the offline conversion (e.g., date of the conversion, value of the conversion, conversion type, and/or other information related to the conversion).

The offline conversion apparatus 130 uses the interaction identifier to identify the particular user interaction with which the identifier is associated, attributes the offline conversion to that particular user interaction, and stores the offline conversion data 126 as conversion data for that particular user interaction. The offline conversion data 126 can be stored, for example in the content performance data store 122. The offline conversion data 126 can be used to facilitate automated bid adjustment in a manner similar to that described above with reference to online conversion data.

For purposes of example, the content distribution system 110, bid adjustment apparatus 124 and offline conversion apparatus 130 are depicted as independent elements of the environment 100. In some implementations, the offline conversion apparatus and/or bid adjustment apparatus 124 can be included as part of the content distribution system 110. Additionally, operations are described in this document as being performed by one of the content distribution system 110, offline conversion apparatus 130, or bid adjustment apparatus 124, but the particular apparatus performing the operations may vary. For example, operations described as being performed by the content distribution system 110 may be performed by the offline conversion apparatus 110 or another data processing apparatus. Similarly, operations described as being performed by the offline conversion apparatus can be performed by the content distribution system 110 or another data processing apparatus.

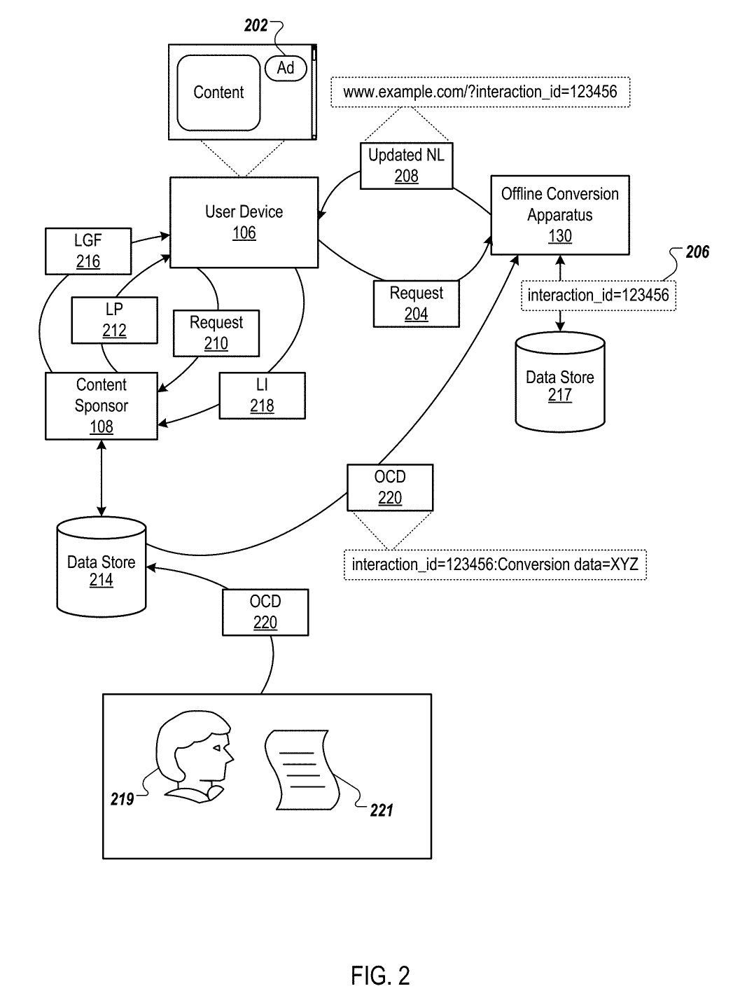

FIG. 2 is a block diagram of an example data flow 200 for tracking offline conversions. For purposes of example, FIG. 2 is described with reference to user interaction with an advertisement. The data flow 200 is also applicable to user interactions with other types of content items (e.g., audio/video files or content items presented in a social network environment).

The data flow 200 begins with a user interaction with a content item, which initiates a request for a network location. For example, a user interaction with (e.g., user click of) the advertisement 202 presented at the user device 106 initiates a request 204 for a network location associated with the offline conversion apparatus 130 or another data processing apparatus. In a particular example, the user interaction can initiate a request for a network location of an interaction apparatus (e.g., which can be part of, or in communication with, the offline conversion apparatus 130) that can store data indicating that user interaction with a content item occurred and can store other information related to the user interaction. The request can include, for example, contextual data associated with the user interaction that can be stored in association with data indicating that the user interaction occurred. For example, the contextual data that are stored can include an advertisement identifier identifying the advertisement 202 with which the user interacted, an identifier (e.g., URL) of a landing page that is being requested through user interaction with the advertisement 202, a date and time at which the user interaction occurred, and/or a resource on which the advertisement was presented.

In response to receiving the request 204, the offline conversion apparatus 130 or the interaction apparatus generates an interaction identifier 206 that uniquely identifies the interaction with the advertisement 202. The interaction identifier can be generated, for example, by generating a hash of data associated with the request (e.g., a hash of at least a portion of the contextual data), or generating a pseudo-random number to be associated with (e.g., stored with or combined with) the contextual data. The offline conversion apparatus 130 or the interaction apparatus can store the interaction identifier 206 in an interaction data store 217 that stores interaction identifiers and contextual data corresponding to the interactions represented by the interaction identifiers. The contextual data can include, for example, information specifying a content item with which the interaction occurred, a search query or resource data corresponding to the presentation of the content item, and other data, e.g., time of interaction and/or type of interaction.

The offline conversion apparatus 130 or the interaction apparatus provides the interaction identifier 206 to the user device 106. In some implementations, the interaction identifier 206 is appended to an updated network location (e.g., an updated URL) from which the user device 106 will request the landing page. For example, the offline conversion apparatus 130 can identify the landing page for the advertisement 202 from the request 204, and provide instructions to the user device 106 that cause the user device to request the network location of the landing page.

The offline conversion apparatus 130 or the interaction apparatus can append the interaction identifier to the end of the network location to create an updated network location 208 for the landing page. For example, assume that the landing page for the advertisement 202 is example.com and that the interaction identifier 206 generated by the offline conversion apparatus 130 is 123456. In this example, the updated network location 208 (“Updated NL) of the landing page that is provided to the user device 106 can be www.example.com/?interaction_id=123456. In turn, the user device 106 can submit a request 210 for the advertisement landing page using the updated network location 208.

In response to receiving the request for the landing page, the content sponsor 108 can provide the landing page 212 (“LP”) to the user device 106 and store the interaction identifier 206. The interaction identifier 206 can be stored in a data store 214 that stores data for the content sponsor 108 and/or in a cookie located at the user device 106. As the user device 106 requests additional pages from the content sponsor, the interaction identifier 206 can continue to be appended to the network location corresponding to each additional page.

In some implementations, the content sponsor 108 can configure a lead generation form 216 (“LGF”) that is provided to the user device. The lead generation form 216 can request lead information 218 (“LI”) from the user. The lead information 218 can include, for example, contact information for a user, products in which the user has interest, and/or other information regarding the user's interest in one or more products or services. The lead generation form 216 can also be configured to obtain the interaction identifier 206 and associate the interaction identifier 206 with the lead information 218 supplied by the user. For example, when the lead generation form 216 is rendered at the user device 106, or submitted by the user device 106, the interaction identifier 206 can be obtained from the requested network location if the interaction identifier 206 is appended to the network location, or obtained from the cookie stored at the user device 106. Thus, when the lead information 218 from the lead generation form 216 is submitted by the user device 106, the interaction identifier 206 will be submitted with that lead information 218.

The content sponsor 108 can store the lead information 218, including the interaction identifier 206, in the data store 214. When a user 219 associated with the lead generation form performs an offline conversion, for example, by entering into a purchase agreement 221 with the content sponsor 108, the content sponsor 108 can update the stored lead information 218 associated with the user 219 (e.g., in a customer relationship management system) to include offline conversion details, which are referred to as offline conversion data 220. The offline conversion data 220 can include, for example, a value of the conversion (e.g., a sales price), a date and/or time when the conversion occurred, and other details about the conversion.

The content sponsor 108 uploads the offline conversion data 220, including the interaction identifier 206, to the offline conversion apparatus 130. For example, the content sponsor 108 can access a content distribution management account and submit the offline conversion data 220 through a user interface that enables submission of the offline conversion data 220. The offline conversion apparatus 130 identifies the interaction identifier 206 from the uploaded conversion data 220, locates a matching interaction identifier in the database 217, and stores the offline conversion data 220 in association with the matching interaction identifier, thereby attributing the conversion to the particular user interaction for which the matching interaction identifier was generated. By attributing the conversion to the particular user interaction, the conversion can also be associated with any other data that corresponds to that particular user interaction (e.g., the content item that was presented, a date/time at which the interaction occurred, a resource on which the content item was presented, or an amount paid for distribution of the content item with which the particular interaction occurred).

In some implementations, validation techniques are utilized to validate the uploaded conversion data 220. For example, when the offline conversion data 220 are received, a determination that the interaction identifier can be successfully decoded can be made prior to storing the offline conversion data 220. Additionally or alternatively, a determination can be made that an account (e.g., a content sponsor account) through which the offline conversion data re being uploaded is authorized to upload the offline conversion data 220. A determination can also be made that the interactions (e.g., stored user interactions) corresponding to the offline conversion data 220 occurred within a specified period of time (e.g., that the interactions are not considered too old to be relied upon). In some implementations, prior to storing the offline conversion data 220, a determination can be made that the offline conversion data 220 being uploaded do not represent offline conversions that have already been reported through a previous upload of offline conversion data.

As described in more detail below, the offline conversion apparatus 130 and/or one or more other data processing apparatus use the stored conversion data 220 in one or more ways, such as to update stored conversion data for an advertisement 202 and generate an adjusted bid that will be used to select content items for presentation. In some implementations, the adjusted bid will be generated based on values of conversions that are associated with the advertisement 202 and/or a likelihood that a user that interacts with the advertisement 202 will ultimately convert. As described below, the adjusted bid can vary based on the context of the impression being auctioned and/or other contextual information that is associated with the impression being auctioned.

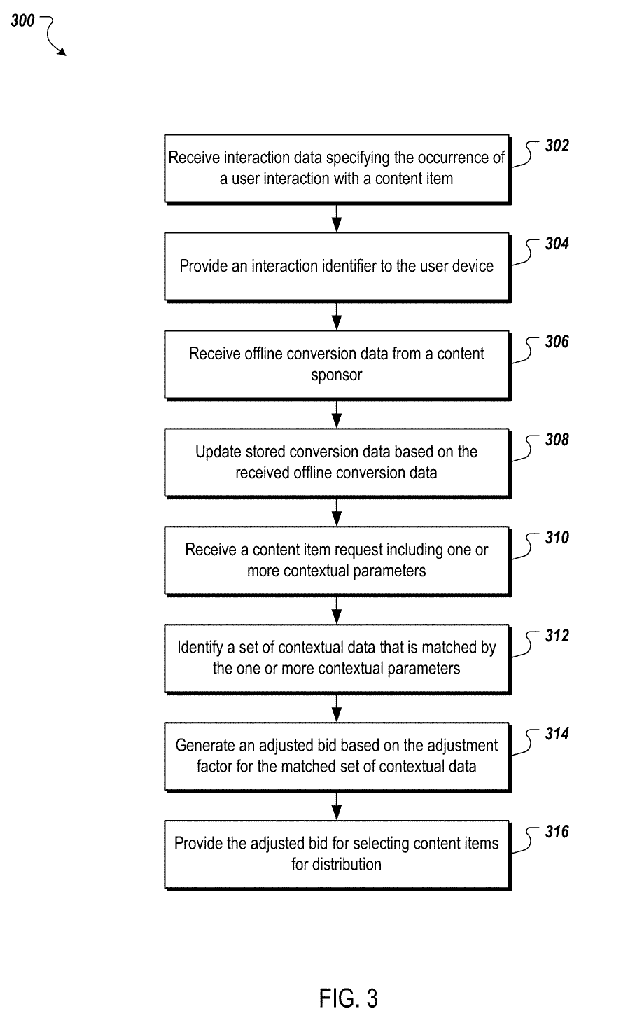

FIG. 3 is a flow chart of an example process 300 for adjusting a bid based on offline conversion data. The process 300 can be performed by one or more data processing apparatus, such as the offline conversion apparatus 130, the content distribution system 110, or another data processing apparatus. Operations of the process 300 can be implemented by execution of instructions stored on a non-transitory computer readable medium. Execution of the instructions causes one or more data processing apparatus to perform operations of the process 300.

Interaction data are received (302). In some implementations, the interaction data are received from a user device and specify the occurrence of a user interaction with a content item. For example, user interaction with a content item, such as an advertisement, can initiate a request to an interaction tracking apparatus, such as a content distribution system, analytics system, or offline conversion apparatus. The interaction data can be stored in association with the content item with which the interaction occurred. For example, data identifying the content item with which the interaction occurred and the type of interaction that was performed can be stored in a data store associated with the data processing apparatus or system that receives the request.

An interaction identifier that is associated with the user interaction is provided to the user device (304). In some implementations, the interaction identifier is provided in response to receiving the interaction data from the user device. For example, in response to receiving the interaction data, an identifier that uniquely identifies the interaction (e.g., the click) can be generated, and provided to the user device. As discussed above, the interaction identifier can be generated using a hashing apparatus, a pseudo-random number generator, or another apparatus that is capable of generating an identifier that uniquely identifies different user interactions.

In some implementations, the interaction identifier is provided to the user device by including the interaction identifier in redirect instructions that are provided to the user device. For example, the interaction data that are received from the user device can specify a network location of a landing page that is being requested through user interaction with the content item. In response to receiving the interaction data, a data processing apparatus can identify the network location of the landing page, and append the interaction identifier to the network location to generate an updated network location, referred to as an updated path, with which the user device can request the landing page.

For example, assume that the network location of the landing page is example.com, and that the interaction identifier that uniquely identifies the particular user interaction is 123456. In this example, the data processing apparatus can identify the network location example.com from the interaction data and append the interaction identifier 123456 to the network location, which will result in an updated path for requesting the landing page. The updated path can be of the form example.com/interaction_id?=123456. The updated path can then be provided to the user device with instructions that cause the user device to request the landing page using the updated path. For example, the updated path can be provided to the user device as part of a redirect instruction that redirects the user to the landing page.

In some implementations, the interaction identifier is also stored in association with contextual data corresponding to the user interaction. For example, the interaction identifier can be stored in a database associated with an offline conversion apparatus, and the contextual data can be stored with a reference to (or indexed according to) the interaction identifier. The contextual data that are stored in association with the interaction identifier can include, for example, data identifying the content item with which the interaction occurred, a type of interaction (e.g., a click of the content item or presentation of an audio or video content item) that occurred, a time of the interaction, a resource on which the content item was presented, and/or any other data that is provided with the interaction data or obtainable using the interaction data.

Offline conversion data are received from a content sponsor associated with the content item (306). In some implementations, the offline conversion data includes the interaction identifier and data regarding an offline conversion that was performed by a user associated with the interaction identifier. For example, the offline conversion data can specify an amount of an offline conversion, a date and/or time of the offline conversion, and/or other data related to the offline conversion.

As discussed above with reference to FIG. 2, the offline conversion data can be obtained by the content sponsor when the content sponsor and a user associated with the interaction identifier engage in a transaction that constitutes a conversion (e.g., a sale or other agreement). In some implementations, the content sponsor is provided the interaction identifier as part of a lead generation process that preceded the conversion. For example, the landing page for the content item with which the user interaction occurred can be a web page that enables a user to enter lead information regarding their interest in various products or services, contact information, and/or other information that enables the content sponsor to evaluate sales opportunities. When the user device reaches this web page using an updated path that includes the interaction identifier, a script in the web page can identify the interaction identifier in the updated path, and associate the interaction identifier with the lead information. In turn, the content sponsor can store the lead information with a reference to the interaction identifier. Thus, the user can be associated with the interaction identifier in the content sponsor's data store. When the conversion is completed, the content sponsor then updates the lead information to include offline conversion details (e.g., a value of the conversion), such that the offline conversion details are also associated with the interaction identifier.

Stored conversion data are updated based on the received offline conversion data (308). In some implementations, the stored conversion data are updated to include the received offline conversion data and/or the details of the offline conversion. For example, the value of the offline conversion (e.g., the revenue or profit generated by the offline conversion) can be stored in association with previously stored conversion data for a content sponsor.

In some implementations, the offline conversion is attributed to the particular user interaction based on the interaction identifier being included in (or received with) the offline conversation data. The offline conversion can be attributed to the particular user interaction, for example, by storing the offline conversion data in association with the interaction identifier. Storing the offline conversion data in association with the interaction identifier can also result in the offline conversion data being stored in association with the content item that is attributed the offline conversion. The content item that is attributed the offline conversion can be, for example, the content item, that when clicked by the user, led to generation of the interaction identifier that is included in the offline conversion data.

As described above, an identifier for a clicked content item can be stored in association with (e.g., with a reference to) a stored instance of the interaction identifier that is generated in response to the content item being clicked. For example, when the offline conversion data are received, the interaction identifier that is received with the offline conversion data can be used to identify a matching identifier in the stored conversion data, or in other stored data. In turn, the offline conversion data, or at least a portion thereof, can be stored in association with the matched identifier, thereby associating the offline conversion data with the matched identifier and any data that has been associated with the matched identifier.

A bid adjustment factor is generated for the content item based on the stored conversion data (310). In some implementations, the bid adjustment factor is a value with which a bid will be adjusted based on a context of an available impression. The context of an available impression can be characterized, for example, based on contextual parameters received with a content item request and/or other available data (e.g., time of day or day of a year).

In some implementations, the bid adjustment factor is computed based, at least in part, on the values of conversions that have been reported through the offline conversion data. For example, using the context of the present impression, content items that were previously presented in response to content item requests having a similar context can be identified, and the values of conversions attributed to those content items (e.g., by way of the association with the interaction identifier) can be used to estimate a value of the present impression. The estimated value of the present impression can be, for example, an average value of the offline conversions associate with the identified content items, or another measure of central tendency or statistical evaluation of the values of the offline conversions. Thus, a different bid adjustment factor can be generated for each of two or more different sets of contextual data that are stored with the offline conversion data. When a content item request is received, the bid adjustment factor corresponding to the set of contextual data matched by contextual parameters received with the content item request can be identified for generating an adjusted bid.

The estimated value of a present impression can be based, at least in part, on an estimated conversion rate for the content item. For example, the value of a present impression for a content item having a higher historical conversion rate (e.g., in the context of the present impression) can generally be higher than the value of the present impression for a content item having a lower historical conversion rate (e.g., in the context of the present impression). Thus, the bid adjustment factor for the content item having the higher historical conversion rate can be higher than the bid adjustment factor for the content item having the lower historical conversion rate.

In some implementations, the value of the bid adjustment factor is based, at least in part, on a difference between the estimated value of the present impression and a historical impression value. For example, assume that the calculated value of all previous impressions is X (e.g., based on total revenue generated by the previous impressions, a number of previous impressions, and/or a historical conversion rate). Further assume that the estimated value of the present impression is 1.2*X based, for example, on the context of the present impression and conversion values associated with contexts matching the context of the present impression. In this example, the bid adjustment factor could be set to 1.2 times the value of a baseline bid adjustment factor.

The baseline bid adjustment factor can be, for example, a bid adjustment factor that is used when the present impression is equal to (or within some threshold amount of) the historical impression value. For example, if the baseline bid adjustment factor is 0.7, then the bid adjustment factor in the example above can be set to 0.84 (i.e., 1.2*0.7) or some other function of the baseline bid adjustment factor.

In some implementations, the bid adjustment factor can be constrained based on a maximum value. For example, the bid adjustment factor can be required to be a value between 0.0 and 1.0. Constraining the bid adjustment factor in such a manner enables the bid adjustment factor to be applied to a content sponsor bid without causing the resulting adjusted bid to have a value that exceeds the bid submitted by the content sponsor. For example, if the maximum bid adjustment value is 1.0, then the product of the bid submitted by the content sponsor and the bid adjustment factor will not result in a value greater than the bid submitted by the content sponsor.

A content item request is received (312). In some implementations, the content item request specifies one or more contextual parameters corresponding to the content item request. For example, the content item request can include any information submitted by the user device, and information that can be generated based on the submitted information.

A set of contextual data that is matched by the one or more contextual parameters associated with the content item request are identified (312). In some implementations, the updated conversion data are evaluated to identify the conversion data that are associated with a set of contextual data that is matched by the one or more contextual parameters. For example, if the content item request includes data specifying a search query that was submitted from the user device, the conversion data can be searched to identify conversion data corresponding to content items that were previously presented in response to content item requests that also included the search query. If multiple contextual parameters are submitted, the conversion data corresponding to one or more of the multiple contextual parameters can be identified.

An adjusted bid is generated based on the bid adjustment factor for the matched set of contextual data (314). In some implementations, the adjusted bid is a value generated based on a bid associated with the content item and the bid adjustment factor for the content item. For example, as described above, the adjusted bid can be a product of (or another function of) the bid adjustment factor and the bid. The bid adjustment factor can be identified, for example, by searching a data store for contextual data that are matched by the one or more contextual parameters. The bid adjustment factor corresponding to the matched contextual data can be used to generate the adjusted bid.

The adjusted bid is provided to select content items for distribution (316). In some implementations, the adjusted bid is submitted for use in a content item selection auction. In turn, the content item selection auction can select a winning bid from among the adjusted bid and other bids that were provided to the content item selection auction, and a content item corresponding to a winning bid can be provided in response to the content item request.

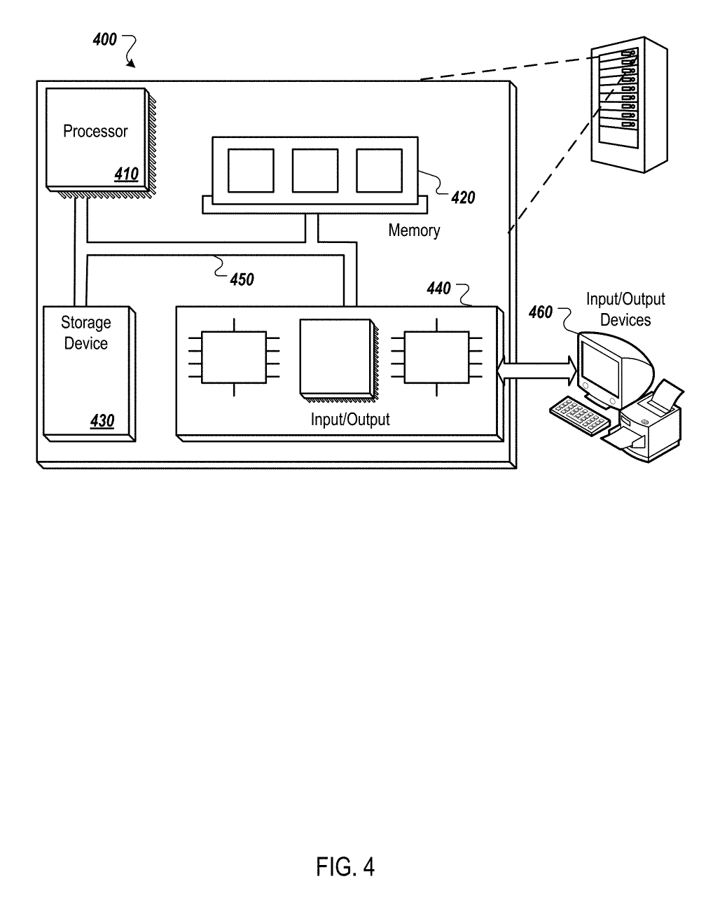

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous

What is claimed is:

1. A method comprising:
receiving, from various user devices and by an offline conversion apparatus including one or more processors, multiple instances of interaction data specifying the occurrence of user interactions with a content item;
providing, to each of the various user devices by the offline conversion apparatus, various different updated paths for a landing page of the content item, including:
for each different user interaction with the content item:
detecting, by the data processing apparatus, a request for the landing page of the content item generated by a particular user interaction with the content item at a particular user device; and
generating, by the data processing apparatus, a unique identifier that uniquely identifies the particular user interaction from others of the user interactions, including generating a hash of contextual data corresponding to the particular user interaction, wherein the contextual data includes at least a time of the particular user interaction;
appending, to a URL of the landing page, the unique identifier that uniquely identifies the particular user interaction from different ones of the user interactions, wherein the appending is performed by the data processing apparatus and prior to redirecting the particular user device to the landing page for the content item;
providing, to the particular user device in the landing page, a lead generation form that requests lead information from the user;
receiving, through the lead generation form presented at the user device, the information including one or more of contact information of the user and a product in which the user has interest;
obtaining, from the URL of the landing page, the unique identifier; and
storing, by the offline conversion apparatus, the lead information received through the lead generation form and the unique identifier obtained from the URL of the landing page together in a data store;
receiving, by the offline conversion apparatus and from a content sponsor associated with the content item, offline conversion data that specifies information corresponding to a given offline conversion and that includes the a given unique identifier obtained from the URL of the landing page for a given user interaction from among the different ones of the user interactions;
validating, by the offline conversion apparatus, the offline conversion data based on a determination that the given offline conversion that was specified in the offline conversion data received from the content sponsor occurred within a specified period of time following the time of the given user interaction identified by the given unique identifier and based on a determination that the offline conversion data do not represent an offline conversion that has already been reported through a previous upload of offline conversion data;
attributing, by the offline conversion apparatus, the offline conversion to the given user interaction based on the validation of the offline conversion data and the information stored in association with the unique identifier;
determining an adjusted bid based at least in part on the attribution of the offline conversion to the given user interaction and a bid associated with the content item, wherein determining an adjusted bid comprises:
generating a bid adjustment factor based on historical conversion data for the content item that includes the offline conversion data for the given offline conversion; and
generating the adjusted bid based on the bid adjustment factor and the bid associated with the content item; and
submitting the adjusted bid to a content item selection process.

2. (canceled)

3. The method of claim 1, comprising:
storing, in a data store, the unique identifier in association with contextual data corresponding to the particular user interaction; and
updating stored conversion data for the content item including:
identifying the stored unique identifier in the offline conversion data; and
storing at least a portion of the offline conversion data in association with the stored unique identifier.

4. (canceled)

5. The method of claim 1, wherein generating a bid adjustment factor comprises generating a different adjustment factor for each of at least two different sets of contextual data, a difference between the different adjustment factors being based, at least in part, on a difference between different conversion values associated with the at least two different sets of contextual data.

6. The method of claim 5, comprising:
receiving a content item request specifying one or more contextual parameters corresponding to the content item request;
identifying a set of contextual data that is matched by the one or more contextual parameters; and
generating an adjusted bid based on the adjustment factor for the set of contextual data that is matched by the one or more contextual parameters.

7. The method of claim 1, wherein generating a bid adjustment factor comprises:
identifying first contextual data of a first context;
identifying offline conversion data for conversions having contextual data that match the first contextual data; and
generating a bid adjustment value based on a value specified by the identified offline conversion data and a difference between an estimated value of a current impression corresponding to the content item request and a baseline value representing a value of multiple previous impressions, including:
determining an average historical impression value based on a ratio of revenue generated by previous offline conversions and a number of previous impressions;
determining an estimated value of the current impression based on the first contextual data and previous conversions that have been attributed to previous impressions that are associated with the first context; and
determining the bid adjustment value based on a difference between the average historical impression value and the estimated value of the current impression.

8. A non-transitory computer storage medium encoded with a computer program, the program comprising instructions that when executed by one or more data processing apparatus of an offline conversion apparatus cause the one or more data processing apparatus of the offline conversion apparatus to perform operations comprising:
receiving, from various user devices, multiple instances of interaction data specifying the occurrence of user interactions with a content item;
providing, to each of the various user devices, various different updated paths for a landing page of the content item, including:
for each different user interaction with the content item:
detecting, by the data processing apparatus, a request for the landing page of the content item generated by a particular user interaction with the content item at a particular user device; and
generating, by the data processing apparatus, a unique identifier that uniquely identifies the particular user interaction from others of the user interactions, including generating a hash of contextual data corresponding to the particular user interaction, wherein the contextual data includes at least a time of the particular user interaction;
appending, to a URL of the landing page, the unique identifier that uniquely identifies the particular user interaction from different ones of the user interactions, wherein the appending is performed by the data processing apparatus and prior to redirecting the particular user device to the landing page for the content item;
providing, to the particular user device in the landing page, a lead generation form that requests lead information from the user;
receiving, through the lead generation form presented at the user device, the information including one or more of contact information of the user and a product in which the user has interest;
obtaining, from the URL of the landing page, the unique identifier; and
storing the lead information received through the lead generation form and the unique identifier obtained from the URL of the landing page together in a data store;
receiving, from a content sponsor associated with the content item, offline conversion data that specifies information corresponding to a given offline conversion and that includes the a given unique identifier obtained from the URL of the landing page for a given user interaction from among the different ones of the user interactions;
validating the offline conversion data based on a determination that the given offline conversion that was specified in the offline conversion data received from the content sponsor occurred within a specified period of time following the time of the given user interaction identified by the given unique identifier and based on a determination that the offline conversion data do not represent an offline conversion that has already been reported through a previous upload of offline conversion data;
attributing the offline conversion to the given user interaction based on the validation of the offline conversion data and the information stored in association with the unique identifier;
determining an adjusted bid based on the attribution of the offline conversion to the given user interaction and a bid associated with the content item, wherein determining an adjusted bid comprises:
generating a bid adjustment factor based on historical conversion data for the content item that includes the offline conversion data for the given offline conversion; and
generating the adjusted bid based on the bid adjustment factor and the bid associated with the content item; and
submitting the adjusted bid to a content item selection process.

9. The computer storage medium of claim 8, wherein the instructions cause the one or more data processing apparatus to perform operations comprising:
storing, in a data store, the unique identifier in association with contextual data corresponding to the particular user interaction; and
updating stored conversion data for the content item including:
identifying the stored unique identifier in the offline conversion data; and
storing at least a portion of the offline conversion data in association with the stored unique identifier.

10. (canceled)

11. The computer storage medium of claim 8, wherein generating a bid adjustment factor comprises generating a different adjustment factor for each of at least two different sets of contextual data, a difference between the different adjustment factors being based, at least in part, on a difference between different conversion values associated with the at least two different sets of contextual data.

12. The computer storage medium of claim 11, wherein the instructions cause the one or more data processing apparatus to perform operations comprising:
receiving a content item request specifying one or more contextual parameters corresponding to the content item request;
identifying a set of contextual data that is matched by the one or more contextual parameters; and
generating an adjusted bid based on the adjustment factor for the set of contextual data that is matched by the one or more contextual parameters.

13. The computer storage medium of claim 8, wherein generating a bid adjustment factor comprises:
identifying first contextual data of a first context;
identifying offline conversion data for conversions having contextual data that match the first contextual data; and
generating a bid adjustment value based on a value specified by the identified offline conversion data and a difference between an estimated value of a current impression corresponding to the content item request and a baseline value representing a value of multiple previous impressions, including:
determining an average historical impression value based on a ratio of revenue generated by previous offline conversions and a number of previous impressions;
determining an estimated value of the current impression based on the first contextual data and previous conversions that have been attributed to previous impressions that are associated with the first context; and
determining the bid adjustment value based on a difference between the average historical impression value and the estimated value of the current impression.

14. A system comprising:
a data store storing a bid associated with a content item; and
an offline conversion apparatus including one or more computers that interact with the data store and execute instructions that cause the offline conversion apparatus to perform operations comprising:
receiving, from various user devices, multiple instances of interaction data specifying the occurrence of user interactions with a content item;
providing, to each of the various user devices, various different updated paths for a landing page of the content item, including:
for each different user interaction with the content item:
detecting, by the data processing apparatus, a request for the landing page of the content item generated by a particular user interaction with the content item at a particular user device;
generating, by the data processing apparatus, a unique identifier that uniquely identifies the particular user interaction from others of the user interactions, including generating a hash of contextual data corresponding to the particular user interaction, wherein the contextual data includes at least a time of the particular user interaction;
appending, to a URL of the landing page, the unique identifier that uniquely identifies the particular user interaction from different ones of the user interactions, wherein the appending is performed by the data processing apparatus and prior to redirecting the particular user device to the landing page for the content item;
providing, to the particular user device in the landing page, a lead generation form that requests lead information from the user;
receiving, through the lead generation form presented at the user device, the information including one or more of contact information of the user and a product in which the user has interest;
obtaining, from the URL of the landing page, the unique identifier; and
storing the lead information received through the lead generation form and the unique identifier obtained from the URL of the landing page together in a data store;
receiving, from a content sponsor associated with the content item, offline conversion data that specifies information corresponding to a given offline conversion and that includes the a given unique identifier obtained from the URL of the landing page for a given user interaction from among the different ones of the user interactions;
validating the offline conversion data based on a determination that the given offline conversion that was specified in the offline conversion data received from the content sponsor occurred within a specified period of time following the time of the given user interaction identified by the given unique identifier and based on a determination that the offline conversion data do not represent an offline conversion that has already been reported through a previous upload of offline conversion data;
attributing the offline conversion to the given user interaction based on the validation of the offline conversion data and the information stored in association with the unique identifier;
determining an adjusted bid based on the attribution of the offline conversion to the given user interaction and a bid associated with the content item, wherein determining an adjusted bid comprises:
generating a bid adjustment factor based on historical conversion data for the content item that includes the offline conversion data for the given offline conversion; and
generating the adjusted bid based on the bid adjustment factor and the bid associated with the content item; and
submitting the adjusted bid to a content item selection process.

15. (canceled)

16. The system of claim 14, wherein the instructions cause the one or more data processing apparatus to perform operations comprising:
storing, in a data store, the unique identifier in association with contextual data corresponding to the particular user interaction; and
updating stored conversion data for the content item including:
identifying the stored unique identifier in the offline conversion data; and
storing at least a portion of the offline conversion data in association with the stored unique identifier.

17. (canceled)

18. The system of claim 14, wherein generating a bid adjustment factor comprises generating a different adjustment factor for each of at least two different sets of contextual data, a difference between the different adjustment factors being based, at least in part, on a difference between different conversion values associated with the at least two different sets of contextual data.

19. The system of claim 18, wherein the instructions cause the one or more data processing apparatus to perform operations comprising:
receiving a content item request specifying one or more contextual parameters corresponding to the content item request;
identifying a set of contextual data that is matched by the one or more contextual parameters; and
generating an adjusted bid based on the adjustment factor for the set of contextual data that is matched by the one or more contextual parameters.

20. The system of claim 14, wherein generating a bid adjustment factor comprises:
identifying first contextual data of a first context;
identifying offline conversion data for conversions having contextual data that match the first contextual data; and
generating a bid adjustment value based on a value specified by the identified offline conversion data and a difference between an estimated value of a current impression corresponding to the content item request and a baseline value representing a value of multiple previous impressions, including:
determining an average historical impression value based on a ratio of revenue generated by previous offline conversions and a number of previous impressions;
determining an estimated value of the current impression based on the first contextual data and previous conversions that have been attributed to previous impressions that are associated with the first context; and
determining the bid adjustment value based on a difference between the average historical impression value and the estimated value of the current impression.
